(19) United States
(12) Patent Application Publication
(10) Pub. No.: US 2006/0134390 A1
(43) Pub. Date: Jun. 22, 2006

(54) Method for producing durably anti-microbial yarns

(76) Inventors: Jan-Min Lin, Benchiao City (TW); Shin-Chieh Chen, Taoyuan City (TW); Tzu-Shiang Huang, Taipei City (TW)

Correspondence Address: KNOBBE MARTENS OLSON & BEAR LLP, 2040 MAIN STREET, FOURTEENTH FLOOR, IRVINE, CA, 92614, US

(21) Appl. No.: 11/293,622

(22) Filed: Dec. 1, 2005

(30) Foreign Application Priority Data
Dec. 2, 2004 (TW) 93137217

(51) Int. Cl. B32B 23/02

(52) U.S. Cl. 428/194

(57) ABSTRACT

A method for producing durably anti-microbial yarns is disclosed. An inorganic anti-microbial material is formed on at least one surface of a knitted fabric by a physical vapor deposition method, and then the knitted fabric is deknitted to anti-microbial yarns. The anti-microbial yarns provide a better wash ability and durably anti-microbial effect, and are suitable to be blended with other yarns to a softer anti-microbial fabric.

### CROSS-RERERENCE TO RELATED APPLICATIONS

This application claims the priority benefit of Taiwan application serial no. 93137217, filed Dec. 02, 2004, the full disclosure of which is incorporated herein by reference.

### FIELD OF THE INVETION

The present invention relates to a method for producing durably anti-microbial yarns, and more particularly, to a method for producing durably anti-microbial yarns having an inorganic anti-microbial material with good adhesion.

### BACKGROUND OF THE INVENTION

Anti-microbial fabrics, which are the fabrics combined with organic or inorganic anti-microbial material thereon, can be produced directly by anti-microbial yarns, alternatively, be subject to a post-treated process with anti-microbial agents for having the anti-microbial function. Comparison with the above two, the former has durable anti-microbial effect and a better washing resistance, however, is difficult to be produced and anti-microbial agents used are more limited. The latter is easy to be treated, but has less washing resistance and anti-microbial effect. Recently, because of lack of superior anti-microbial yarns, the anti-microbial fabrics are mostly produced on the post-treated process among the commercially available products.

In addition to different treatments, the anti-microbial effect further depends on the anti-microbial agents. The anti-microbial agents are generally divided into organic or inorganic anti-microbial agents. The inorganic anti-microbial agents have advantages like long-term effect and low skin irritation, resulting in application to the anti-microbial treatment on textiles.

The inorganic anti-microbial agents are applied on textiles by using following manners in the prior art. For example, an inorganic substance, ceramic, or ion-exchangeable clay is utilized to act as a silver carrier. Related examples of such can be found in U.S. Pat. Nos. 6,514,622, 6,495,367, 6,476,095, 6,461,386, 6,361,567 and 6,288,076, and the above all is recited as references herein.

In another way, a polymer like hydrogel or soluble polymer is utilized to act as a silver carrier. Related examples of such can be found in U.S. Pat. No. 6, 495,367, 6,238,686, 6,294,186, 6,264,936 and 6,224,898, and the above all is recited as references herein.

Otherwise, a surface of a material is plated with an anti-microbial metal in an electroplating manner. Related examples of such can be found in U.S. Pat. Nos. 6,451,003 and 6,267,782, and the above two are recited as references herein.

Besides, physical vapor deposition (PVD) method is used to produce ultra-thin metal particles for enhancing the solubility of the metal ions. Related examples of such can be found in U.S. Pat. Nos. 6,333,093, 6,017,553, and 5,985,308, and the above all is recited as references herein.

The aforementioned prior arts, in sum, are not beyond the above description, for example, utilizing various carriers, electroplating or PVD, to improve the releasing rate and solubility of the inorganic anti-microbial materials. However, there are some issue existed in the prior arts as follows. As the inorganic substance, ceramic, or ion-exchangeable clay acts as a silver carrier, the releasing rate is slower and the releasing time is short. The surfactant or other gel dispersing technologies must be utilized for enhancing the carrier particles uniformly dispersed in the material, resulting in the increase of the process complexity. Moreover, adding and dispersing carrier particles belong to the front-end process. Nevertheless, that will directly increase the difficulty of the back-end process.

Moreover, the polymer acting as the silver carrier is difficult to control the releasing rate of silver ions. In addition, the hydrogel or soluble polymer is supposed to be cytotoxic, and the polymer additive is hazardous to human body while exuding.

Furthermore, as an object is plated with the anti-microbial metal in the electroplating manner, the electroplating solution may contain some hazardous substances. And, the amount of the anti-microbial metal utilized in electroplating is much higher than other manners, but the anti-microbial effect is not significantly increased. That consumes lots of the anti-microbial material. Additionally, the electroplated metal film is more than 1 micrometer in thickness, leading the metal film to peel off due to stress or rubbing when such anti-microbial fabric treated by electroplating is worn.

Besides, as PVD is utilized to produce ultra-thin metal particles, it needs to restrict the introducing gases, pressure and temperature for preventing the ultra-thin metal particles from thickening. The resultant ultra-thin metal particles have disadvantages, for example, concentrated and uneven distribution causes uneasily reduced cost, and redundant output of the ultra-thin metal particles are more than the requirement for the anti-microbial agent on the general garment. Moreover, as such for the water-absorbent and hydrophilic fabrics, the vacuum operation of the PVD must spend more time to ensure the complete removal of water content in the yarns of such fabrics. Furthermore, as such for the existing equipments, they are not suitable for forming the ultra-thin metal particles on a single yarn, and it must be spent more cost on modifying or changing the design of the vacuum chamber when directing at producing anti-microbial yarns. In addition, the resultant anti-microbial fabric cannot bear washing, rubbing or bending, so it cannot be subject to a mass production.

### SUMMARY OF THE INVENTION

It is an aspect of the present invention to provide a method for producing durably anti-microbial yarns, which forms an inorganic anti-microbial material with good adhesion on at least one surface of a knitted fabric by a PVD method, followed by deknitting the knitted fabric to anti-microbial yarns, so that the anti-microbial yarns are blended with other yarns to produce an anti-microbial fabric. A distribution area of the inorganic anti-microbial material can be effectively controlled by the method for producing durably anti-microbial yarns. Thus, the process cost is reduced drastically, and it provides a better wash ability and durable anti-microbial effect. Moreover, the durably anti-microbial yarns can be produced in a batch-type or continuous-type process. In addition, the anti-microbial fabric is improved to be softer, and provides a better wash ability and durable anti-microbial effect.

It is another aspect of the present invention to provide a durably anti-microbial multi-filament yarn, which is characterized by having an inorganic anti-microbial material formed thereof. The inorganic anti-microbial material is formed as ultra-thin crystallites and a film formed continuously and by turns along an axial direction of the anti-microbial multi-filament yarn.

According to the aforementioned aspect of the present invention, there is provided a method for producing durably anti-microbial yarns. A knitted fabric is firstly provided, wherein the knitted fabric is a circular knitted fabric or a flat knitted fabric. Next, an inorganic anti-microbial material is formed on at least one surface of the knitted fabric by a PVD method. And then, the knitted fabric with the inorganic anti-microbial material formed thereon is deknitted to an anti-microbial yarn.

Preferably, the PVD method may be a sputtering method or an evaporation method.

Preferably, a target composed of at least one metal or non-metal material may be employed to form the inorganic anti-microbial material during the PVD method.

According to the still another aspect of the present invention, there is further provided a durably anti-microbial multi-filament yarn, which is characterized by having an inorganic anti-microbial material formed thereof. The inorganic anti-microbial material is formed as ultra-thin crystallites and a film formed continuously and by turns along an axial direction of the anti-microbial multi-filament yarn.

The method for producing durably anti-microbial yarns, when applied to produce the durably anti-microbial fabric, forms an inorganic anti-microbial material with good adhesion on at least one surface of a knitted fabric by the PVD method followed by deknitting the knitted fabric to anti-microbial yarns, so that the anti-microbial yarns are blended with other yarns to produce the anti-microbial fabric. Thus, the process cost is reduced drastically, the anti-microbial fabric is improved to be softer and provides a better wash ability and durable anti-microbial effect, as well as to produced in a batch-type or continuous-type process.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a process flowchart of durably anti-microbial yarns according to a preferred embodiment of the present invention.

### DETAILED DESCRIPTION OF THE PREFERRED EMBODIMENT

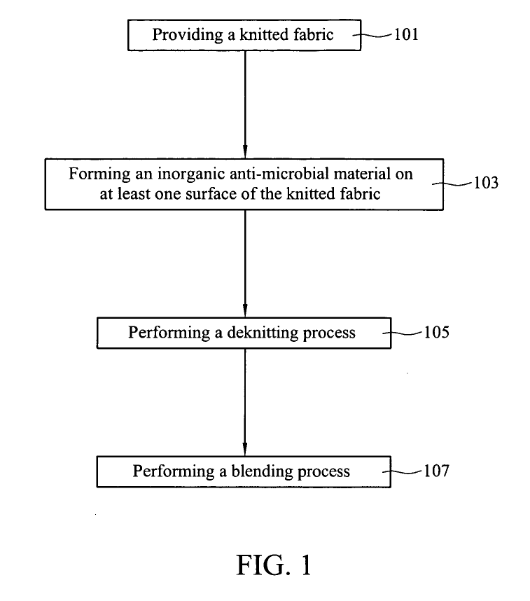

The present invention provides a method for producing durably anti-microbial yarns, which forms an inorganic anti-microbial material with good adhesion on at least one surface of a knitted fabric by the PVD method, followed by deknitting the knitted fabric to anti-microbial yarns, so that the anti-microbial yarns are blended with other yarns to produce an anti-microbial fabric. Hereinafter, the method for producing durably anti-microbial yarns is more explicitly clarified in the following description in conjugation with FIG. 1.

Reference is made to FIG. 1, which is a process flowchart of durably anti-microbial yarns according to a preferred embodiment of the present invention. As shown in the step 101, a knitted fabric is firstly provided, wherein the knitted fabric is a circular knitted fabric or a flat knitted fabric. Next, as shown in the step 103, an inorganic anti-microbial material is formed on at least one surface of the knitted fabric by a PVD, for example, a sputtering method or an evaporation method. Specifically, a target composed of at least one metal material or non-metal material is employed to form the inorganic anti-microbial material during the PVD. According to a preferred embodiment of the present invention, the at least one metal material may be gold, silver, cupper, aluminum, platinum, tantalum, bismuth, zinc or any combinations thereof. According to another preferred embodiment of the present invention, the at least one non-metal material may include but not be limited by oxides of Ag, Au, Cu, Fe, Zn, Ti, Bi, Be, Pt, Pd, Ni, Ta or any combinations thereof.

In an example of the present invention, the target composed of pure silver is employed to perform the sputtering method in the presence of an inert gas and a vacuum environment at a pressure ranging from 10⁻³ torrs to 10⁻⁶ torrs. Alternatively, the target composed of two atoms with large difference in particle sizes, for example, the target composed of more than 95% silver by weight and less than 5% gold or platinum by weight, is employed to perform the sputtering method in the presence of an inert gas and oxygen, and a vacuum environment at a pressure ranging from 10⁻³ torrs to 10⁻⁶ torrs. The appropriate inert gas may be helium, neon, argon or krypton. Depending on the target material used, the inorganic anti-microbial material formed in the above manner may be gold, silver, cupper, aluminum, platinum, tantalum, bismuth, zinc or any combinations thereof. Because the metalized surface of the knitted fabric in opposition to the target is affected by the knitting manner, various formed states of the resultant inorganic anti-microbial material, for example, ultra-thin crystallites and a film, are formed continuously by turns along an axial direction of the anti-microbial yarn. For example, when the formed amount of the target atoms on the yarns of the knitted fabric is more, the formed state of the inorganic anti-microbial material typically leads to be a film. On the contrary, when the formed amount of the target atoms on the yarns of the knitted fabric is less, the formed state of the inorganic anti-microbial material typically leads to be a distribution of ultra-thin crystallites, and the ultra-thin crystallites are 1 nm to 100 nm in diameter. However, as is understood by a person skilled in the art, the PVD method is merely employed to form the inorganic anti-microbial material on the at least one surface of the foregoing knitted fabric, other inorganic anti-microbial material can be further utilized or combined, rather than being limited by the above examples.

It is worth mentioning that the present invention utilizes the inorganic anti-microbial material with good adhesion formed on at least one surface of the knitted fabric followed by deknitting the knitted fabric to anti-microbial yarns, so that both of the process material and cost are reduced more drastically than the prior process, instead of the prior skill forms the inorganic anti-microbial material directly on the surface of a single yarn resulting in difficultly controlling the distribution region of the inorganic anti-microbial material. Furthermore, the present invention obtains the anti-microbial yarns from the knitted fabric with anti-microbial treatment, and thus the anti-microbial yarns can be produced in a batch-type or continuous-type process for speeding the process. Besides, the anti-microbial yarns produced by the present invention is characterized by the various formed states of the resultant inorganic anti-microbial material, for example, ultra-thin crystallites and a film, which are formed continuously and by turns along the axial direction of the durably anti-microbial yarn.

After the inorganic anti-microbial material is formed, as shown in the step 105, a deknitting process is performed, which fixes one end of the knitted fabric followed by drawing a thread end from another end of the knitted fabric and fixing the thread end onto a winding machine, by the winding machine to deknit the knitted fabric continuously, so as to obtain the anti-microbial yarn. According to a preferred embodiment of the present invention, 50% to 90% of a surface of the anti-microbial yarn is covered with the inorganic anti-microbial material, and an amount of the inorganic anti-microbial material is 0.001% to 1% by weight with respect to the anti-microbial yarn.

After the deknitting process, as shown in the step 107, a blending process is performed for blending the anti-microbial yarn and other yarn in a ratio, wherein a kind of the blended yarn is not limited but depends on the product requirement, so as to form various anti-microbial fabrics. Besides, the ratio of the anti-microbial yarn blended with the yarn also depends on the product requirement, for example, ranging from 1:1 to 1:10, but more preferably, the ratio ranging from 1:1 to 1:5, so as to obtain the anti-microbial fabric with different softness. For example, the higher ratio of the anti-microbial yarn blended is used, the better and the harder anti-microbial fabric is obtained, and vice versa, the lower ratio of the anti-microbial yarn blended is used, the good and the softer anti-microbial fabric is obtained. The anti-microbial yarn and the anti-microbial fabric blended with thereof by the present invention provide better wash ability and durable anti-microbial effect.

Hereinafter, the method for producing durably anti-microbial yarns and the application thereof are more explicitly clarified in the following embodiments rather than to be interpreted as limiting of the present invention. Therefore, the scope of the present invention should be accorded the appended claims.

### EXAMPLE 1

Polyethylene terephthalate (PET) yarns are knitted to a circular knitted fabric by a circular knitting machine, wherein the circular knitting machine is a small stitch-variable circular knitting machine having a cylinder with 3.5 inches in diameter, and the PET yarns are 75D/144F draw textured yarns (DTY). The above circular knitted fabric is 46 yarns per inch in the warp density and 26 yarns per inch the weft density. Next, the silver target with 99.999% purity is employed to sputter silver atoms on the both surfaces of the circular knitted fabric in the presence of argon using a flow rate of 100 standard cubic centimeter per minute (sccm) at a pressure of about 10⁻³ torrs, wherein the silver amount is 0.004% to 0.01% by weight with respect to the circular knitted fabric.

And then, the silver-coated circular knitted fabric is deknitted at a speed of about 100 cm per minute, so as to obtain silver-coated PET yarns. Afterwards, the silver-coated PET yarns are blended with PET yarns in a ratio of 1:1. The resultant anti-microbial fabric is subject to a washing test and anti-microbial test.

### EXAMPLE 2

PET yarns are knitted to a circular knitted fabric by a circular knitting machine, wherein the circular knitting machine is a small stitch-variable circular knitting machine having a cylinder with 3.5 inches in diameter, and the PET yarns are 75D/144F DTY. The above circular knitted fabric is 46 yarns per inch in the warp density and 26 yarns per inch the weft density. Next, the target having about 99% silver doped with about 1%. platinum is employed to sputter silver/platinum atoms on the both surfaces of the circular knitted fabric in the presence of about 80% argon and about 20% oxygen by volume, at a pressure of about 10⁻⁴ torrs, so as to form silver/platinum on the both surfaces of the circular knitted fabric, wherein the silver amount is 0.004% to 0.01% by weight with respect to the circular knitted fabric.

And then, the silver/platinum-coated circular knitted fabric is deknitted at a speed of about 100 cm per minute, so as to obtain silver/platinum-coated PET yarns. Afterwards, the silver/platinum-coated PET yarns are blended with PET yarns in a ratio of 1:1. The resultant anti-microbial fabric is subject to a washing test and anti-microbial test.

### EXAMPLE 3

PET yarns are knitted to a flat knitted fabric by a flat knitting machine, wherein the flat knitting machine is a 12G/inch flat knitting machine, and the PET yarns are 150D/288F DTY. The above flat knitted fabric is 20 yarns per inch in the warp density and 16 yarns per inch the weft density. Next, the silver target with 99.999% purity is employed to sputter silver atoms on the both surfaces of the circular knitted fabric in the presence of argon at a pressure of about 10⁻³ torrs, so as to form silver on the both surfaces of the flat knitted fabric, wherein the silver amount is 0.004% to 0.01% by weight with respect to the circular knitted fabric.

And then, the silver-coated flat knitted fabric is deknitted at a speed of about 100 cm per minute, so as to obtain silver-coated PET yarns. Afterwards, the silver-coated PET yarns are blended with PET yarns in a ratio of 1:1. The resultant anti-microbial fabric is subject to a washing test and anti-microbial test.

### EXAMPLE 4

PET yarns are knitted to a flat knitted fabric by a flat knitting machine, wherein the flat knitting machine is a 12G/inch flat knitting machine, and the PET yarns are 150D/288F DTY. The above flat knitted fabric is 20 yarns per inch in the warp density and 16 yarns per inch the weft density. Next, the target having about 99% silver doped with about 1% platinum is employed to sputter silver/platinum atoms on the both surfaces of the flat knitted fabric in the presence of about 80% argon and about 20% oxygen by volume, at a pressure of about 10⁻⁴ torrs, so as to form silver/platinum on the both surfaces of the flat knitted fabric, wherein the silver amount is 0.004% to 0.01% by weight with respect to the circular knitted fabric.

And then, the silver/platinum-coated flat knitted fabric is deknitted at a speed of about 100 cm per minute, so as to obtain silver/platinum-coated PET yarns. Afterwards, the silver/platinum-coated PET yarns are blended with PET yarns in a ratio of 1:1. The resultant anti-microbial fabric is subject to a washing test and anti-microbial test.

### EXAMPLE 5

The resultant anti-microbial fabrics of EXAMPLES 1 to 4 are subject to a washing test and anti-microbial test, according to the Sen-i Evaluation Kinou (SEK) standard established by Japan Association for the Function Evaluation of Textile (JAFET). The anti-microbial fabrics of EXAMPLES 1 to 4 are subject to washing in several times or not, followed by cutting them to an appropriate size. After sterilization, a constant amount of test microbes, such as Staphylococcus aureus, are inoculated and cultured. After cultured for 18 hours, numbers of the uncultured microbes (A), cultured microbes on the untreated fabric sample (B), and cultured microbes on the anti-microbial fabric sample (C) are measured respectively. All measured microbe numbers are converted to logarithms. As logB−logA>1.5, the test is established, logA−logC refers to a bactericidal value, and logB−logC refers to a bacteriostatic value. As logB−logC>2.2, the fabric sample has a bactericidal effect, and as C<A, the fabric sample has a bacteriostatic effect. The result of anti-microbial fabrics of EXAMPLES 1 to 4 subject to the washing test and anti-microbial test is shown as the following TAB. 1:

TABLE 1

| Anti-microbial fabrics of | | |
|---|---|---|
| EXAMPLES 1 to 4 | Before washed | After washed in 50 times |
| Bacteriostatic value | 5.30 | 5.71 |
| Bactericidal value | 2.90 | 3.20 |

As shown in TAB. 1, after the anti-microbial fabrics of the present invention are subject to be washed in 50 times, the bacteriostatic and bactericidal values are both higher to the SEK standard and have no significant change. That is to say, the inorganic anti-microbial material on various fabrics is adhered very well, and the resultant anti-microbial fabrics provide a better wash ability and durable anti-microbial effect.

In addition, the resultant anti-microbial fabric of EXAMPLES 1 is further subject to another washing test and anti-microbial test, according to the anti-microbial standard AATCC 100-1999 established by American Association of the Textile Chemists and Colorists (AATCC). The anti-microbial fabric of EXAMPLES 1 is subject to washing in several times or not, followed by cutting them to an appropriate size. After sterilization, a constant amount of test microbes, such as Staphylococcus aureus, are inoculated and cultured. After cultured for 18 hours, numbers of cultured microbes on the anti-microbial fabric sample (A), the uncultured microbes on the anti-microbial fabric sample (B), and cultured microbes on the untreated fabric sample (C) are measured respectively. The result of anti-microbial fabric of EXAMPLES 1 subject to the washing test and anti-microbial test is shown as the following TAB. 2:

TABLE 2

| | Untreated | Anti-microbial |
|---|---|---|
| Reduction (%) = 100 × (B − A)/B | fabric | fabric |
| After washed in 50 times | 99.93% | 99.88% |
| After washed in 100 times | 99.73% | 99.93% |
| After washed in 150 times | 99.93% | 99.46% |
| After washed in 200 times | 99.88% | 99.73% |
| After washed in 250 times | 99.93% | 98.69% |
| After washed in 300 times | 99.93% | 99.93% |

As shown in TAB. 2, after the anti-microbial fabric of the present invention is subject to be washed in even 300 times, all reduction percentages are higher than 99.90% and have no significant change. This result is further proved that the inorganic anti-microbial material of the present invention on various fabrics are adhered very well, and the resultant anti-microbial fabrics provide a better wash ability and durable anti-microbial effect.

By the way, the method for producing durably anti-microbial yarns provided by the present invention can be practiced to produce personal, indoor, medical, sport products or the like. The personal products are such as heavy garments, gloves, boots, underwears, hats and the like. The indoor products are such as baby/child/elder healthy garments, bedcovers, electric blankets, quilts and the like. The medical or sport products are such as medical protective garments, therapeutic pads, wristlet, sportswears and the like.

In brief, the method for producing durably anti-microbial yarns of the present invention is characterized by forming the inorganic anti-microbial material with good adhesion on the surface of the knitted fabric, followed by deknitting the knitted fabric to anti-microbial yarns, and after the knitted fabric can effectively control a distribution area of the inorganic anti-microbial material, so that the anti-microbial yarns are blended with other yarns to produce an anti-microbial fabric. Therefore, the process cost is reduced drastically, and the durably anti-microbial yarns can be produced in a batch-type or continuous-type process.

According to the aforementioned preferred embodiments, one advantage of the method for producing durably anti-microbial yarns of the present invention forms an inorganic anti-microbial material with good adhesion on the surface of a knitted fabric by the PVD method, followed by deknitting the knitted fabric to anti-microbial yarns, so that the anti-microbial yarns are blended with other yarns to produce an anti-microbial fabric. The knitted fabric can effectively control a distribution area of the inorganic anti-microbial material. Thus, the process cost is reduced drastically, and the durably anti-microbial yarns can be produced in a batch-type or continuous-type process.

According to the aforementioned preferred embodiments, another advantage of the method for producing a durably anti-microbial fabric of the present invention forms an inorganic anti-microbial material with good adhesion on at least one surface of a knitted fabric by the PVD method, followed by deknitting the knitted fabric to anti-microbial yarns and blending the anti-microbial yarns with other yarns to produce an anti-microbial fabric. Therefore, the anti-microbial fabric is improved to be softer, and provides a better wash ability and durable anti-microbial effect.

As is understood by a person skilled in the art, the foregoing preferred embodiments of the present invention are illustrated of the present invention rather than limiting of the present invention. It is intended to cover various modifications and similar arrangements included within the spirit and scope of the appended claims. Therefore, the scope of which should be accorded the broadest interpretation so as to encompass all such modifications and similar structure.

What is claimed is:

1. A method for producing durably anti-microbial multi-filament yarns, comprising:
providing a knitted fabric selected from the group consisting of a circular knitted fabric and a flat knitted fabric;
forming an inorganic anti-microbial material on at least one surface of a knitted fabric by a PVD method; and
performing a deknitting process for deknitting the knitted fabric to an anti-microbial multi-filament yarn.

2. The method for producing durably anti-microbial multi-filament yarns according to claim 1, wherein the PVD method is selected from the group consisting of a sputtering method and an evaporation method.

3. The method for producing durably anti-microbial multi-filament yarns according to claim 2, wherein the sputtering method is carried out in the presence of an inert gas and a vacuum environment at a pressure ranging from 10⁻³ torrs to 10⁻⁶ torrs.

4. The method for producing durably anti-microbial multi-filament yarns according to claim 3, wherein the inert gas is selected from the group consisting of helium, neon, argon and krypton.

5. The method for producing durably anti-microbial multi-filament yarns according to claim 2, wherein the evaporation method is carried out in the presence of an inert gas and oxygen, and a vacuum environment at a pressure ranging from 10⁻³ torrs to 10⁻⁶ torrs.

6. The method for producing durably anti-microbial multi-filament yarns according to claim 5, wherein the inert gas is selected from the group consisting of helium, neon, argon and krypton.

7. The method for producing durably anti-microbial multi-filament yarns according to claim 2, wherein a target composed of at least one metal material is employed to form the inorganic anti-microbial material during the PVD method.

8. The method for producing durably anti-microbial multi-filament yarns according to claim 7, wherein the at least one metal material is selected from the group consisting of gold, silver, cupper, aluminum, platinum, tantalum, bismuth, zinc and any combinations thereof.

9. The method for producing durably anti-microbial multi-filament yarns according to claim 2, wherein the inorganic anti-microbial material is a non-metal material selected from the group consisting of oxides of Ag, Au, Cu, Fe, Zn, Ti, Bi, Be, Pt, Pd, Ni, Ta and any combinations thereof.

10. The method for producing durably anti-microbial multi-filament yarns according to claim 1, wherein a formed state of the inorganic anti-microbial material is ultra-thin crystallites or a film formed continuously and by turns along an axial direction of the anti-microbial multi-filament yarn.

11. The method for producing durably anti-microbial multi-filament yarns according to claim 10, wherein the ultra-thin crystallites are 1 nanometer (nm) to 100 nm in diameter.

12. The method for producing durably anti-microbial multi-filament yarns according to claim 1, wherein 50% to 90% of a surface of the anti-microbial multi-filament yarn is covered with the inorganic anti-microbial material.

13. The method for producing durably anti-microbial multi-filament yarns according to claim 1, wherein an amount of the inorganic anti-microbial material is 0.001% to 1% by weight with respect to the anti-microbial multi-filament yarn.

14. The method for producing durably anti-microbial multi-filament yarns according to claim 1, wherein the deknitting process further comprises:
fixing one end of the knitted fabric; and
drawing a thread end from another end of the knitted fabric and fixing the thread end onto a winding machine, by the winding machine to deknit the knitted fabric continuously, so as to obtain the anti-microbial multi-filament yarn.

15. The method for producing durably anti-microbial multi-filament yarns according to claim 1, further comprising blending the anti-microbial multi-filament yarn and another multi-filament yarn in a ratio ranging from 1:1 to 1:10 after the deknitting process.

16. The method for producing durably anti-microbial multi-filament yarns according to claim 1, further comprising blending the anti-microbial multi-filament yarn and another multi-filament yarn in a ratio ranging from 1:1 to 1:5 after the deknitting process.

17. A durably anti-microbial multi-filament yarn, which is characterized by being formed from fibers having an inorganic anti-microbial material formed thereof, and the inorganic anti-microbial material is formed as ultra-thin crystallites or a film formed continuously and by turns along an axial direction of the anti-microbial multi-filament yarn.

18. The durably anti-microbial multi-filament yarn according to claim 17, wherein the inorganic anti-microbial material is selected from the group consisting of gold, silver, cupper, aluminum, platinum, tantalum, bismuth, zinc and any combinations thereof.

19. The durably anti-microbial multi-filament yarn according to claim 17, wherein the inorganic anti-microbial material is a non-metal material selected from the group consisting of oxides of Ag, Au, Cu, Fe, Zn, Ti, Bi, Be, Pt, Pd, Ni, Ta and any combinations thereof.

20. The durably anti-microbial multi-filament yarn according to claim 17, wherein the ultra-thin crystallites are 1 nm to 100 nm in diameter.

21. The durably anti-microbial multi-filament yarn according to claim 17, wherein 50% to 90% of a surface of the durably anti-microbial yarn is covered with the inorganic anti-microbial material.

22. The durably anti-microbial multi-filament yarn according to claim 17, wherein an amount of the inorganic anti-microbial material is 0.001% to 1% by weight with respect to the anti-microbial yarn.
